(19) United States
(12) Patent Application Publication
(10) Pub. No.: US 2026/0011830 A1
(43) Pub. Date: Jan. 8, 2026

(54) IMPROVED COUPLING BETWEEN BATTERY COVER AND BASE

(71) Applicant: Apple Inc., Cupertino, CA (US)

(72) Inventors: Daeshin Lee, San Jose, CA (US); Liubin Zhou, Shenzhen (CN); Rajesh Kandibanda, San Jose, CA (US); Joshua M. Chien, San Francisco, CA (US); Samuel C. Billand, San Francisco, CA (US); Manuel Nicholas Franco Henriques, Mountain View, CA (US)

(73) Assignee: Apple Inc., Cupertino, CA (US)

(21) Appl. No.: 18/766,568

(22) Filed: Jul. 8, 2024

(51) Int. Cl. H01M 50/169; H01M 10/04; H01M 10/058; H01M 50/103; H01M 50/15

(52) U.S. Cl. CPC H01M 50/169; H01M 10/049; H01M 10/058; H01M 50/103; H01M 50/15

(57) ABSTRACT

A battery comprising a base including a base portion defining an interior volume and a base flange extending from the base portion. The battery also includes a battery cell stack positioned in the interior volume. The battery also includes a cover welded to the base flange with a plurality of welds that at least partially overlap.

### BACKGROUND

As electronic devices develop in functionality, there is a commensurate demand to decrease the size of the electronic devices. At the same time, there is a demand for the electronic device to maintain a certain level of battery performance. However, the performance of the electronic device may be limited by the shape and size of the battery.

### BRIEF SUMMARY

One aspect of the disclosure provides for a battery comprising a base including a base portion defining an interior volume and a base flange extending from the base portion. The battery also includes a battery cell stack positioned in the interior volume. The battery also includes a cover welded to the base flange with a plurality of welds that at least partially overlap.

Implementations may include one or more of the following features. The plurality of welds overlap to define an overlapping weld having an overlap volume percentage of between 30% and 50% of a total volume of the plurality of overlapping welds. The plurality of overlapping welds includes a first portion having a first width and a second portion having a second width that is less than the first width. The base flange extends from the base portion to a base flange end and the first portion includes a first weld end terminally aligned with the base flange end. The base flange extends from the base portion to a base flange end, and the second portion includes a second weld end terminally aligned with the base flange end. The base flange extends from the base portion to a base flange end, the plurality of overlapping welds includes a third portion positioned between the first portion and the second portion, the third portion includes a third width less than the first width and the second, and the third portion includes a third weld end terminally aligned with the base flange end. A first weld of the plurality of welds extends through the base and cover a first distance, and a second weld of the plurality of welds extends through the base and cover a second distance greater than the first distance. The first weld extends through the base a distance less than a thickness of the base flange and the second weld fully extends through the thickness of the base. The base flange and the base portion defines a base corner therebetween, and the battery further comprises a bracket positioned on the base corner. The battery comprises a covering material positioned over the plurality of overlapping welds.

Another aspect of the disclosure provides for a battery comprising a base including a base portion defining an interior volume and a base flange extending from the base portion. The battery also includes a battery cell stack positioned in the interior volume. The battery also includes a cover welded to the base flange with a first weld and a second weld at least partially overlapping with the first weld.

Implementations may include one or more of the following features. The battery where the first weld and second weld overlap to define an overlapping weld having an overlap volume percentage of between 30% and 50% of a total combined volume of the first and second welds. The first and second welds define a first portion having a first width and a second portion having a second width that is less than the first width. The base flange extends from the base portion to a base flange end and the first portion includes a first weld end terminally aligned with the base flange end. The base flange extends from the base portion to a base flange end and the second portion includes a second weld end terminally aligned with the base flange end. The base flange extends from the base portion to a base flange end, the first and second welds define a third portion positioned between the first portion and the second portion, the third portion includes a third width less than the first width and the second, and the third portion includes a third weld end terminally aligned with the base flange end. The base flange and the base portion defines a base corner therebetween, and the battery further may comprise a bracket positioned on the base corner. The battery further may comprise a covering material positioned over the first and second welds.

Yet another aspect of the disclosure provides for a method of forming a battery comprising inserting a battery cell stack in an interior volume defined by a base portion of a base sheet. The method also includes welding a cover sheet to a base flange of the base sheet with a first weld, where the base flange extends from the base portion. The method also includes welding the cover sheet to the base flange with a second weld at least partially overlapping the first weld. The method also includes cutting the cover sheet and the base sheet to form the battery.

Implementations may include one or more of the following features. The method further may comprise: determining, with a scanner, a geometric profile of the base sheet and the cover sheet; determining weld locations based on the geometric profile; and welding the first weld and second weld based on the weld locations.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts a cross-sectional view of a prior art battery.

FIG. 2 depicts a cross-sectional view of a battery according to an embodiment of the disclosure.

FIG. 3 depicts a cross-sectional view of a battery according to an embodiment of the disclosure.

FIG. 4 depicts a cross-sectional view of a battery according to an embodiment of the disclosure.

FIG. 5 depicts a cross-sectional view of a battery according to an embodiment of the disclosure.

FIG. 6A depicts an isometric view of a battery according to an embodiment of the disclosure.

FIG. 6B depicts a cross-sectional view of the battery of FIG. 6A along Section A-A according to an embodiment of the disclosure.

FIG. 7 depicts a cross-sectional view of a battery according to an embodiment of the disclosure.

FIG. 8 depicts a cross-sectional view of a battery according to an embodiment of the disclosure.

FIG. 9A depicts a cross-sectional of a base sheet and a cover sheet with a first weld according to an embodiment of the disclosure.

FIG. 9B depicts a cross-sectional view of the battery of FIG. 9A of the base sheet and the cover sheet with a double weld according to an embodiment of the disclosure.

FIG. 10 depicts a flowchart for forming a battery according to an embodiment of the disclosure.

FIG. 11 depicts a block diagram of an example computer system usable with systems and methods according to embodiments of the present disclosure.

### DETAILED DESCRIPTION

When batteries are coupled in a battery pack or electronic device, the batteries may occupy an effective volume, defined by the volume of the major dimensions of the batteries, within that battery pack or electronic device. However, the particular shape and size of certain features of the battery (e.g., the battery enclosure) may effectively prevent other components (e.g., a battery cell, electrode tab, or other components) from occupying the space within the effective volume. In other words, certain features of the battery may have a shape and/or size that renders certain portions of the effective volume a dead space (e.g., a space that cannot be easily occupied by another component other than the battery). Accordingly, it is desirable to maximize the amount of space that is useable by the battery by minimizing the dead space within this effective volume. This may include minimizing a total effective volume of the battery.

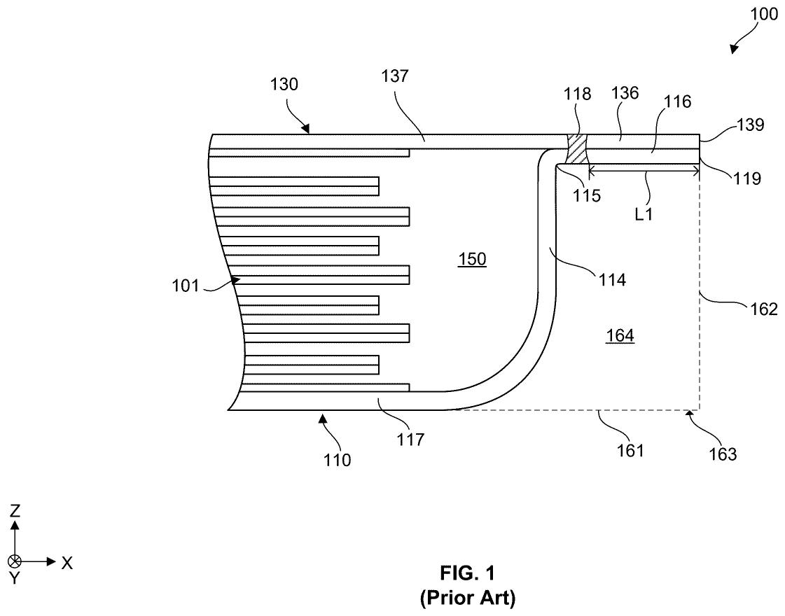

An example of a battery with excessive dead space may be seen in FIG. 1. FIG. 1 depicts a partial cross-sectional view of an example prior art battery 100. The battery 100 may have a base 110 and a cover 130 coupled together via welding, brazing, soldering, gluing, or the like. The base 110 and the cover 130 may have a major dimension (e.g., a major height 162 and a major width 161) that defines the battery 100 to have an effective volume 163. The base 110 and the cover 130 may define an interior volume 150 therebetween. In particular, the base sidewall 114 and a base main wall 117 may define a base portion that partially defines the interior volume 150. The battery 100 may include a battery cell stack 101 (e.g., one or more of a cathode layer, anode layer, a separator, and current collector) positioned in the interior volume 150. The portion of the effective volume 163 that is not occupied by the interior volume 150 or the battery 100 may be a dead space 164. When the battery 100 is coupled within a battery pack or electronic device, the battery 100 may have a large amount of dead space 164 due to certain features of the battery 100.

For example, the base 110 may include a base flange 116 extending from the base sidewall 114 of the base portion to a base flange end 119 external to the interior volume 150. The cover 130 may include a cover main wall 137 and a cover extension portion 136 extending past the base sidewall 114 along an X-axis external to the interior volume 150 to a cover flange end 139. The base 110 and the cover 130 may be coupled to each other at the base flange 116 and the cover extension portion 136 through a weld 118. The weld 118 may be a single weld coupling the base flange 116 and the cover extension portion 136 together. Although one weld 118 is depicted, it is understood that the battery 100 may include multiple welds spaced from each other coupling the base 110 and the cover 130 together at other portions of the battery 100 that are not depicted in FIG. 1.

The lengths of the base flange 116 and the cover extension portion 136 may correspond to a minimum length required to enable the base 110 and the cover 130 to be sufficiently coupled to each other along the base flange 116 and the cover extension portion 136 (e.g., enough length for the base flange 116 and the cover extension portion 136 to be seam welded together) while also providing enough space for the ends 119, 139 to be formed by laser cutting without affecting the peel strength of the weld 118 (e.g., the force required to peel the base flange 116 and the cover extension portion 136 from each other at the weld 118). In particular, during manufacturing of the battery 100, the base 110 may be part of a larger base sheet and the cover 130 may be part of a larger cover sheet. The sheets may be coupled together, such as being welded together by the weld 118. After the weld 118 is formed, the base 110 and the cover 130 may be formed by laser cutting off excess portions of each sheet a length L1 (e.g., about 40 μm or greater) from the weld 118.

This length L1 minimizes the risk that the heat from the laser cutting negatively impacts the strength of the weld 118. For example, if the laser cutting is performed too close to the weld 118, the peel strength of the weld 118 may be reduced. As such, where the weld 118 is a single weld, the length L1 allows for the base flange 116 and the cover extension portion 136 to be formed without interfering with the strength of the weld 118. However, the length L1 increases the effective volume 163 and dead space 164 of the battery 100 because the dimensions of the base flange 116 and the cover extension portion 136 create a space within the effective volume 163 that is not easily occupied by other components. As such, it is desirable to minimize the length L1 to decrease the effective volume 163 of the battery 100 without negatively impacting the peel strength of the weld 118.

Additionally, the base 110 may include a base corner 115 formed when a base sheet is stamped (e.g., from a drawn metal stamping process) to form the base 110. The base corner 115 may be particularly thin compared to the rest of the base 110 as a result of the stamping process bending the base 110 to form the base corner 115. In some examples, the base corner 115 can be greater than 30% thinner than the rest of the base 110. The thinness of the base corner 115 can be especially susceptible to damage (e.g., breaking at the base corner 115) when, for example, the battery 100 is dropped. As such, it is desirable to strengthen the base corner 115 to minimize the risk that the battery 100 breaks at the base corner 115.

The present disclosure addresses these issues by providing a battery with improved coupling between the base and the cover. In particular, the battery may include one or more designs that allow for the base and cover to be coupled to each other with a stronger connection while optimizing the battery size. For example, the battery may include a double weld between the cover and the base. This double weld includes a greater peel strength than a single weld while also providing resistance to additional heating. As such, the battery may be formed with laser cutting closer to the double weld than conventional batteries, thus decreasing the effective volume and dead space of the battery. Additionally or alternatively, a bracket may be coupled to certain corners of the base to increase the structural integrity of those corners and prevent those corners from being damaged if the battery is dropped while allowing for the radius of those corners to be smaller, thus increasing the useable space within the effective volume of the battery.

Although the remaining portions of the description may routinely reference lithium-ion battery cells, it will be readily understood by the skilled artisan that the technology is not so limited. The present designs may be employed with any number of battery or energy storage devices, including other rechargeable and primary, or non-rechargeable, cell types, as well as electrochemical capacitors also known as supercapacitors or ultracapacitors, electrolysers, fuel cells, and other electrochemical devices. Moreover, the present technology may be applicable to battery cells and energy storage devices used in any number of technologies that may include, without limitation, phones and mobile devices, handheld electronic devices, wearable devices, laptops and other computers, appliances, heavy machinery, transportation equipment, spacecraft electronics payloads, vehicles, as well as any other device that may use battery cells or benefit from the discussed designs. Accordingly, the disclosure and claims are not to be considered limited to any particular example discussed, but can be utilized broadly with any number of devices that may exhibit some or all of the electrical or chemical characteristics of the discussed examples.

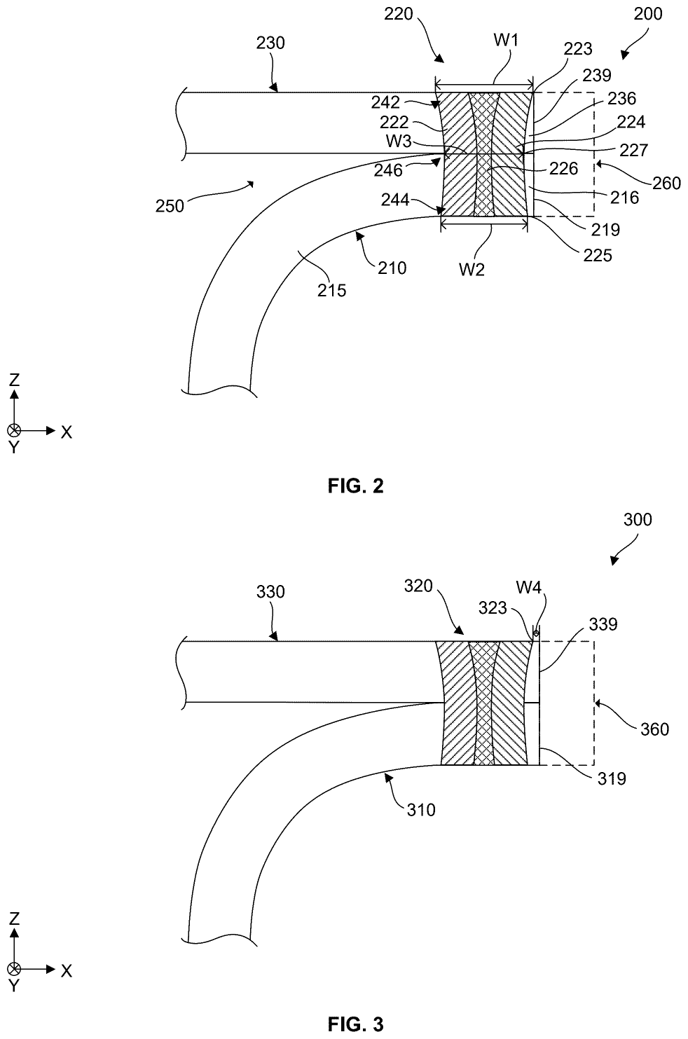

As noted above, the cover and bases of conventional batteries are coupled together with a single weld (e.g., the weld 118, as shown in FIG. 1). This single weld can be weakened when exposed to heat, such as during the laser cutting process, which can lead to decreased peel strength between the cover and the base. As such, conventional batteries are laser cut with a large distance from the single weld to the edges of the battery formed by the laser cutting. However, this increases the effective and dead space of the battery. The present disclosure addresses this issue by providing a double weld between the cover and the base that has a stronger peel strength and greater heat resistance than the single weld of conventional batteries. For example, FIG. 2 depicts a battery 200 including a double weld 220. It is understood that features ending in like reference numerals as features discussed above are similar, except as noted below. The base 210 and the cover 230 may be coupled together at the double weld 220. The double weld 220 may fully extend through both the cover 230 and the base 210. The double weld 220 may include a first weld 222 and a second weld 224 welded over each other such that the two welds 222, 224 form an overlapping weld 226.

The overlapping weld 226 may have a volume forming an overlap volume percentage of the total volume of the double weld 220 (e.g., an overlap volume percentage). A higher overlap volume percentage may be beneficial to minimize the size of the weld 220, which can, in turn, decrease the effective volume of the battery 200 by allowing for the battery 200 to be laser cut to a smaller size. However, too high of an overlap volume percentage may negatively impact the material properties of the weld 220, such as by decreasing the hardness of the weld 220. As such, the overlapping weld 226 may include an overlap volume percentage of between about 5% and 50% of the total volume of the double weld 220, such as about 15% and 40%, or such as between about 25% and 35%. The overlapping weld 226 may include a cross-sectional overlap along the X-axis of between about 20 μm and 100 μm, such as between about 30 μm and 90 μm, such as between about 40 μm and 80 μm, such as between about 50 μm and 70 μm, or about 60 μm.

The double weld 220 may have a different width along the X-axis the portions of the double weld 220. A larger width of the double weld 220 may result in the base 210 and the cover 230 having a stronger peel strength at the double weld 220. However, if the width of the double weld 220 is too large, the effective volume of the battery 200 may be increased, as well as introducing cosmetic quality issues. As such, the widths of the various portions of the double weld 220 may be a balance between the peel strength of the base 210 and the cover 230, and the effective volume and aesthetic of the battery 200.

The double weld 220 may include a first portion 242, a second portion 244, and a third portion 246 corresponding to different portions of the double weld 220 along a Z-axis. For example, the first portion 242 may be a top portion of the double weld 220 along the Z-axis (e.g., a top portion of the double weld 220). The first portion 242 may be a portion of the double weld 220 that is only in the cover 230. The second portion 244 may be a bottom portion of the double weld 220 along the Z-axis (e.g., a bottom portion of the double weld 220). The second portion 244 may be a portion of the double weld 220 that is only in the base 210. The third portion 246 may be a middle portion of the double weld 220 along the Z-axis (e.g., a throat portion of the double weld 220). The third portion 245 may be a portion of the double weld 220 that is in both the base 210 and the cover 230.

The first portion 242 include a first width W1, the second portion 244 may have a second width W2, and the third portion 246 may have a third width W3. Each of the portions 242, 244, 246 may have a different width. However, in other embodiments, one or more of the portions of the double weld may have a similar width. For example, the first width and the second width may be substantially similar (e.g., the first width and the second width may be within about a 20% deviation of each other, such as about a 10% deviation, such as about a 5% deviation, or being completely the same). The first width W1 may be between about 90 μm and 160 μm, such as between about 100 μm and 150 μm, such as between about 120 μm and 140 μm, or about 130 μm. In some embodiments, the first width W1 may preferably be about 135 μm. The third width W3 may be between about 50 μm and 130 μm, such as between about 60 μm and 120 μm, such as between about 70 μm and 110 μm, such as between about 80 μm and 100 μm, or about 90 μm. In some embodiments, the third width W3 may preferably be about 90 μm.

The double weld 220 allows for the battery 200 to be formed with the flange ends 219 239 closer to the double weld 220 compared to conventional batteries, which lowers the effective volume of the battery 200. In particular, as the double weld 220 is heated twice from the two welds 222, 224, the double weld 220 may be more resistant to heat, such as heat emitted from laser cutting. In turn, this greater heat resistance may allow for the battery 200 to be formed with flange ends 219 239 closer to the double weld 220. For example, the volume 260 represents the amount of material that can be removed compared to a conventional battery. Whereas the conventional battery includes a cover and base having a large distance from the weld to the ends (e.g., the length L1 of the base 110 and the cover 130, as shown in FIG. 1) as represented by the volume 260, the battery 200 can be laser cut such that the flange ends 219 239 is closer to the double weld 220. In one example, the flange ends 219 239 can be terminally aligned along an X-axis with a first weld end 223 of the double weld 220 such that there is no excess material extending along the X-axis past the first weld end 223.

The double weld 220 may decrease the effective volume and dead space of the battery 200. Decreasing a length of the base flange 216 and cover extension portion 236 may decrease the effective volume of the battery 200 by decreasing an overall space occupied by the battery 200. As such, shortening the base flange 216 and cover extension portion 236 may decrease the effective volume of the battery 200. At the same time, decreasing the length of the base flange 216 and cover extension portion 236 may also decrease a dead space in the effective volume of the battery 200. For example, as discussed above, due to the difficulty in positioning other components below the base flange 216 along a Z-axis, the area below the base flange 216 may be considered a dead space. As such, shortening the base flange 216 and cover extension portion 236 may also decrease the area below the base flange 216, thus decreasing the dead space in the effective volume of the battery 200. Accordingly, as the double weld 220 allows for the battery 200 to be formed without the material represented by the volume 260, the double weld 220 allows for the battery 200 to be formed with a shorter base flange 216 and cover extension portion 236 compared to conventional batteries, therefore decreasing the effective volume and dead volume of the battery 200 compared to conventional batteries. However, in other embodiments, one or more of the flange ends and/or weld end may not be terminally aligned with each other.

The double weld 220 may be formed between the base 210 and the cover 230 just past the base corner 215 along the X-axis. For example, the double weld 220 may be formed where the base corner 215 ends, and the base flange 216 and cover extension portion 236 begin. In this manner, the effective volume of the battery 200 may be reduced by forming the double weld 220 closer to the base corner 215. However, in some embodiments, the double weld may be formed with a small distance from the base corner.

Each of the welds 222, 224 may be formed with a laser that extends from the cover 230 to the base 210. However, in other embodiments, the laser may extend from the base to the cover. The power, speed, and pattern of the laser may be selected based on the material (e.g., steel, aluminum, tin, copper, or the like) and thickness of the base 210 and cover 230, as well as the desired weld strength between the base 210 and the cover 230. In other embodiments, the welds 222, 224 may be welded through arc welding, metal inert gas welding, stick welding, tungsten inert gas welding, other types of gas welding, or the like.

Each of the welds 222, 224 may be formed with a substantially similar power and speed (e.g., the power and speed used for each of the welds 222, 224 may be within about a 20% deviation of each other, such as about a 10% deviation, such as about a 5% deviation, or being completely the same). For example, the welds 222, 224 may be formed with a power between 100 W and 300 W, such as between about 125 W and 275 W, such as between about 150 W and 260 W, such as between about 175 W and 225 W, or about 200 W. The welds 222, 224 may be formed with a speed between about 300 mm/s and 900 mm/s, such as between about 400 mm/s and 800 mm/s, such as between about 500 mm/s and 700 mm/s, or about 600 mm/s.

Either of the welds 222, 224 may be welded first. For example, the first weld 222 may be welded first and then the second weld 224 may be welded to at least partially overlap the first weld 222 after. However, in other embodiments, the second weld may be provided first and then the first weld may be welded to at least partially overlap the second weld after. After the welds 222, 224 are welded, the battery 400 may be formed by laser cutting form the flange ends 219 239.

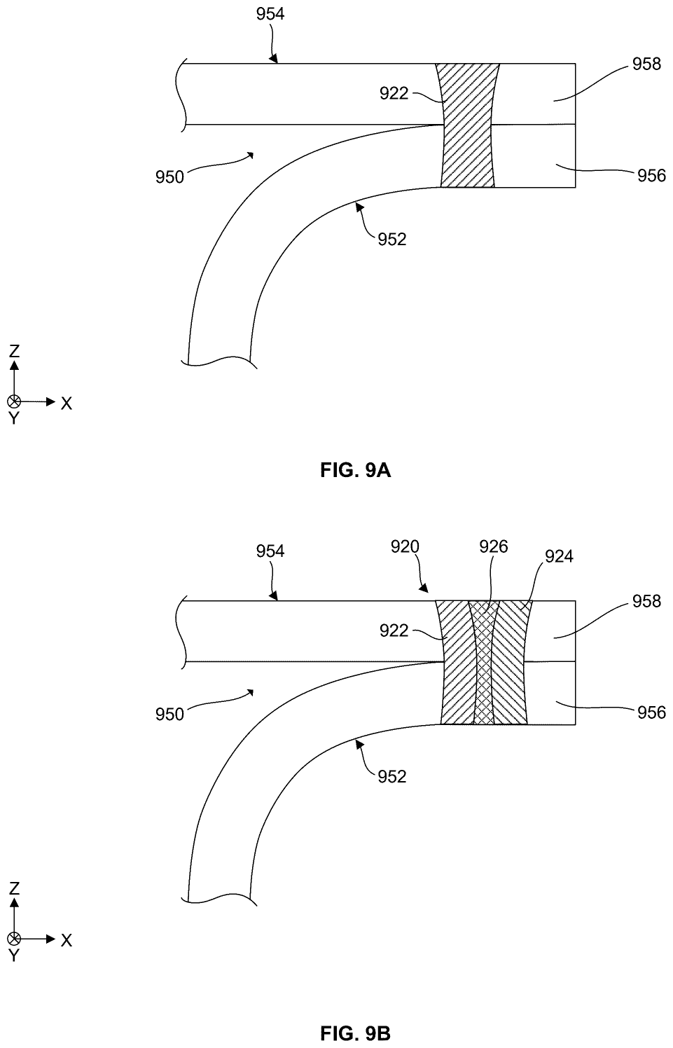

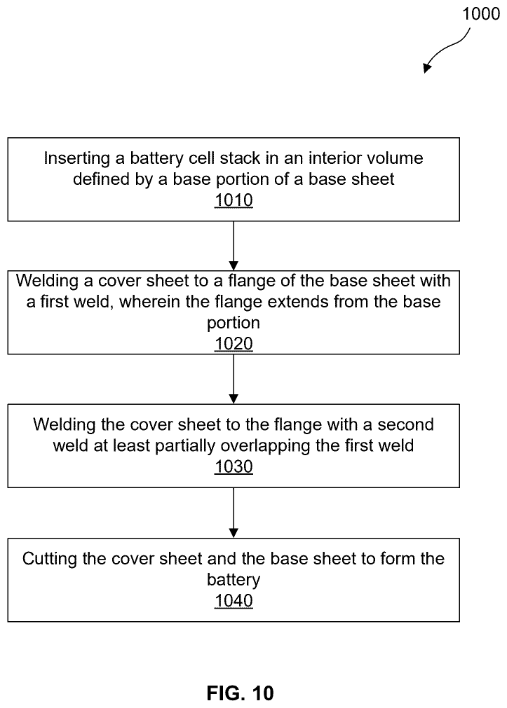

In some embodiments, prior to welding the double weld 220, a three-dimensional (3D) scanner may be used to scan the geometric profile of the larger base sheet (e.g., the base sheet 952, as shown in FIGS. 9A and 9B) that forms the base 210 and the larger cover sheet (e.g., the cover sheet 954, as shown in FIGS. 9A and 9B) that forms the cover 230. This may be beneficial to determine the locations of where to weld the welds 222, 224 as it may be difficult to form a consistent size and shape of the overlapping weld 226 between the base 210 and the cover 230 given the small size of the welds 222, 224. In particular, once the geometric profiles of the base sheets are scanned, a computer system (e.g., the computer system 1010, as shown in FIG. 10) may determine the weld locations along those base sheets to weld the welds 222, 224 (e.g., a particular distance from the base corner 215). In this manner, using the 3D scanner enables the welds 222, 224 to be positioned relative to each other more precisely and consistently given the small sizes of the welds 222, 224 and the welding locations along the base and cover sheets.

In other embodiments, the flange ends of the base and cover are a distance away from the first weld end to provide a small buffer between the laser cutting and the double weld. For example, FIG. 3 depicts a battery 300. It is understood that features ending in like reference numerals as features discussed above are similar, except as noted below. The flange ends 319, 339 are distanced a buffer width W4 from the first weld end 323. The buffer width W4 may be just large enough that a small buffer is provided between the double weld 320 and the flange ends 319, 339. This may be beneficial to account for a margin of error when laser cutting to form the battery 300. For example, the buffer provided by the buffer width W4 may minimize any decrease in peel strength of the double weld 320 if the laser used in the laser cutting is stronger than expected. The buffer width W4 may be less than about 30 μm, such as less than about 20 μm, or about 10 μm. Although the buffer width W4 extends along the X-axis past the first weld end 323, the buffer width W4 may still be less material that the material used in conventional batteries. For example, even with the buffer width W4, the battery 300 may have less material extending past the first weld end 323 compared to conventional batteries, as represented by the volume 360.

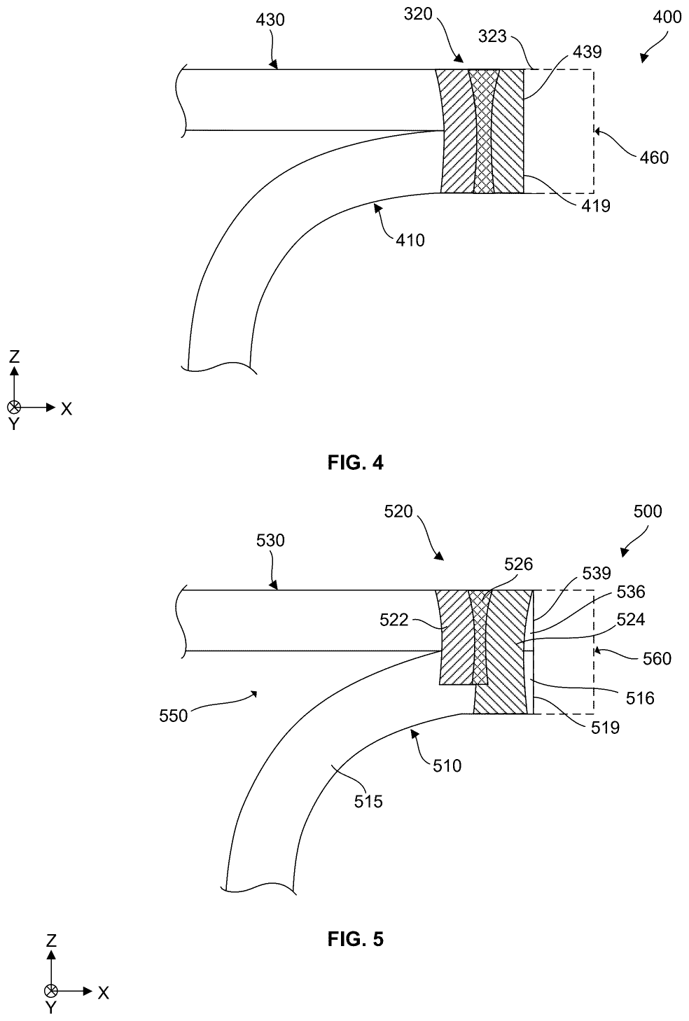

In yet other embodiments, the ends of the base and the cover may extend into the double weld to further minimize the effective volume of the battery. For example, FIG. 4 depicts an example battery 400. It is understood that features ending in like reference numerals as features discussed above are similar, except as noted below. The battery 400 may be formed with the flange ends 419, 439 laser cut through a portion of the double weld 420. The battery 400 may be formed such that no unwelded portion of the base 410 or cover 430 are exposed at the flange ends 419, 439. The flange ends 419, 439 may be laser cut into the double weld 420 a distance from a weld end formed when welding the double weld 420 (e.g., a distance from a first weld 224, as shown in FIG. 2) to further minimize the effective volume of the battery 400 while still offering good peel strength between the base 410 and the cover 430. For example, the flange ends 419, 439 may be laser cut between about 5 μm and 40 μm into the double weld 420 from a weld end of the double weld 420 when the double weld 420 was initially welded, such as between about 10 μm and 30 μm, or such as between about 15 μm and 20 μm, or the like. In some embodiments, the flange ends may be laser cut along a portion of the double weld 4 having the smallest width of the double weld (e.g., up to a third weld end 227 of a third portion 246 of the double weld 220, as shown in FIG. 2) or at an intermediate width of the double weld (e.g., up to a second weld end 225 of a second portion 244, as shown in FIG. 2). In these latter examples, a portion of the unwelded base and cover may be exposed at the flange ends.

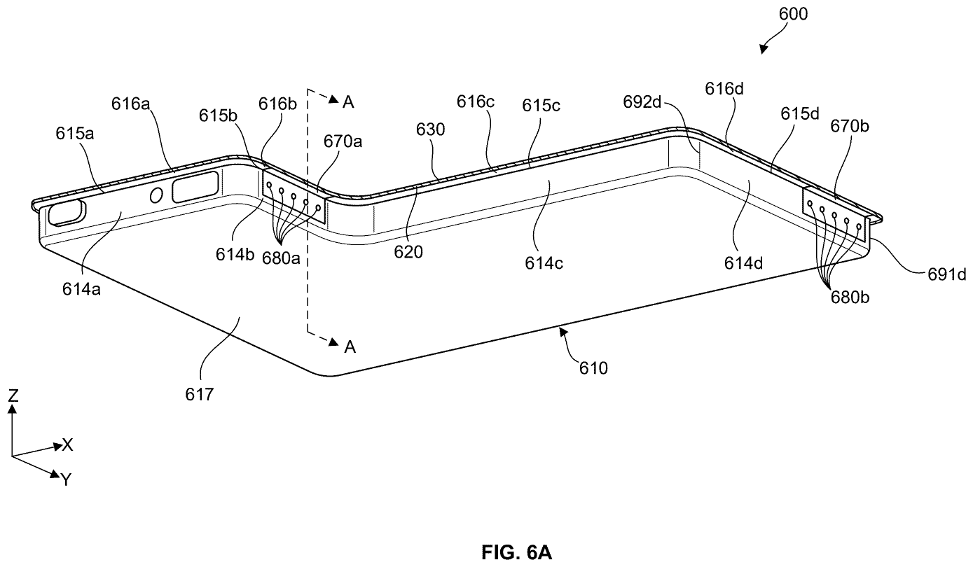

In some embodiments, only some of the welds may fully extend through both the cover and the base. For example, FIG. 5 depicts an example battery 500. It is understood that features ending in like reference numerals as features discussed above are similar, except as noted below. The first weld 522 may extend entirely through the cover 530 and only partially through the base 510. In other words, the first weld 522 may extend through the base flange 516 a distance less than a thickness of the base flange 516 along the Z-axis. The second weld 524 may fully extend through both the cover 530 and the base 510. As the first weld 522 does not completely extend through the base 510, the base corner 515 of the base 510 can be formed with a smaller radius (e.g., compared to the base corner 215, as shown in FIG. 2). In turn, this can increase the interior volume 550 of the battery 500, allowing for more components to be housed in the battery 500 (e.g., a larger battery cell stack). The double weld 520 may still provide an increased peel strength over conventional coupling methods between the base 510 and the cover 530 (e.g., a single weld 118, as shown in FIG. 1). In other embodiments, the second weld may partially extend through the base flange while the first weld may fully extend through the base flange. In yet other embodiments, both the first weld and the second weld may only partially extend the base. In a yet further embodiment, when the double weld is formed by penetrating from the base to the cover, the first weld and/or the second weld may only partially extend the cover. In a yet further embodiment, both the first and send welds may only partially extend through the base or cover. The double weld 520 may be formed by, when using a laser weld, providing a first power and/or speed to the first weld 522 that is less than a second power to the second weld 524.

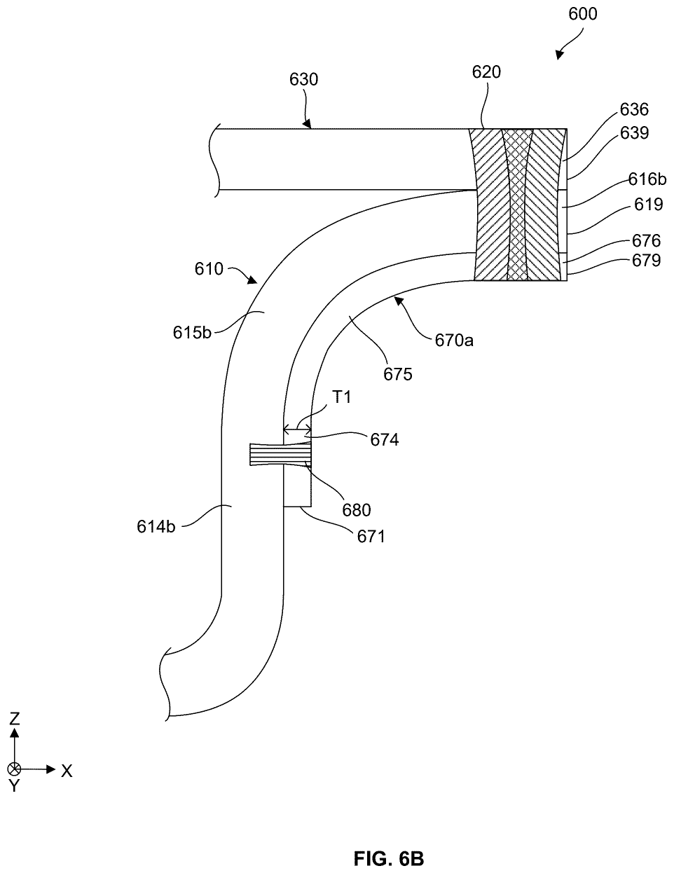

As noted above, in conventional batteries, the base corners of the base (e.g., the base corner 115) may be particularly thin as a result of forming the base through a stamping process and, therefore, may be particularly susceptible to being damaged when dropped. The present disclosure addresses this issue by providing a bracket along that base corner to strengthen the structural integrity of that base corner. For example, FIGS. 6A and 6B depict an example battery 600 including a first bracket 670a and a second bracket 670b. It is understood that features ending in like reference numerals as features discussed above are similar, except as noted below. With reference to FIG. 6A, the base 610 may include a first base corner 615a between a first base sidewall 614a and a first base flange 616a, a second base corner 615b between a second base sidewall 614b and a second base flange 616b, a third base corner 615c between a third base sidewall 614c and a third base flange 616c, and a fourth base corner 615d between a fourth base sidewall 614d and a fourth base flange 616d. The base 610 may include other base corners defined between a base flange and a base sidewall not shown in FIG. 1A (e.g., other base corners on other points of view of the battery 600 that is not shown in FIG. 1A). The base sidewalls 614a, 614b, 614c, 614d and the base main wall 617 may define a base portion that receives a battery cell stack.

The first bracket 670a may be positioned on the second base corner 615b to strengthen the structural integrity of the second base corner 615b and the second bracket 670c may be positioned on the fourth base corner 615d to strengthen the structural integrity of the fourth base corner 615d. The brackets 670a, 670b may be positioned on the base corners 615b, 615d, in particular, because the base corners 615b, 615d may be especially prone to damage when the battery 600 is dropped with a drop test compared to the other base corners 615a, 615c (and other base corners of the battery 600 not shown in FIGS. 6A and 6B). However, in other embodiments, the brackets may be additionally or alternatively be positioned on any other base corner to increase the structural integrity of those other base corners.

The second bracket 670b, may be coupled adjacent a first wall end 691d of the fourth base sidewall 614d and away from a second wall end 692d of the fourth base sidewall 614d as, using the same drop test, the portion of the fourth base corner 615d adjacent the first wall end 691d may be especially prone to damage. However, in other embodiments, the second bracket may be positioned along any portion of the fourth base sidewall, including adjacent the second wall end or along an intermediate portion of the fourth base sidewall. Although two brackets 670a, 670b are depicted, in other embodiments, there may be more or less than two brackets. For example, there may be only one bracket on one of the base corners. In other examples, there may be more than two brackets, such as one bracket for each available base corner.

The double weld 620 may couple the first bracket 670a to the second base flange 616b and the second bracket 670b to the fourth base flange 616d. The first bracket 670a may be coupled to the second base sidewall 615b through a first spot weld set 680a. The second bracket 670b may be coupled to the fourth base sidewall 615d through a second spot weld set 680b. Although the brackets 670a, 670b are depicted as being coupled to the base flanges 616b, 616d through the double weld 620, in other embodiments, the brackets may be coupled to the base flanges through a single weld, such as the single weld 118 shown in FIG. 1. The spot weld in each spot weld set 680a, 680b may be laterally spaced from each other along a width of the brackets 670a, 670b. Although each spot weld set 680a, 680b is depicted as including five spot welds on the corresponding brackets 670a, 670b, in other embodiments, each bracket may include more or less than five spot welds, such as one spot weld, two spot welds, six spot welds, seven spot welds, or the like. Further, each bracket may not include a similar amount of spot welds and, instead, may each have a different amount of spot welds.

FIG. 6B depicts a cross-sectional view of the bracket 670a along Section A-A. Although the following disclosure will describe the first bracket 670a in greater detail, it is understood that the following description can also apply to the second bracket 670b and corresponding fourth corner 615d. The first bracket 670a may include a bracket sidewall 674, a bracket flange 676 and a bracket corner 675 therebetween. The bracket sidewall 674 may be positioned against the second base sidewall 614b, the bracket corner 675 may be positioned against the second base corner 615b, and the bracket flange 676 may be coupled against the second base flange 616b.

The bracket corner 675 may include a substantially similar radius as the second base corner 615b (e.g., the radius of the bracket corner 675 and the second base corner 615b may be within about a 20% deviation of each other, such as about a 10% deviation, such as about a 5% deviation, or being completely the same). However, in other embodiments, each the radius of the bracket corner and the second base corner may be different. The bracket flange 676 may include a substantially similar length along an X-axis as the second base flange 619b and the cover extension portion 636 (e.g., the length of the bracket flange 676, the second base flange 619b, and the cover extension portion 636 may be within about a 20% deviation of each other, such as about a 10% deviation, such as about a 5% deviation, or being completely the same) such that first bracket end 679 may be terminally aligned ends 619, 639. The length of the bracket flange 676, the second base flange 619b, and the cover extension portion 636 may share a substantially similar length as a result of the base 610, cover 630, and first bracket 670a being laser cut together (e.g., after the base 610, cover 630, and first bracket 670a are welded together at the first double weld 620a). However, in other embodiments, one or more of the base flange end, cover flange end, and/or the bracket end may not be terminally aligned with each other. In yet other embodiments, one of the welds of the double weld may not fully extend through the bracket flange, such as only partially extending through the bracket flange. A length of the bracket sidewall 674 along a Z-axis may be between about 1 mm and 5 mm, such as between about 2 mm and 4 mm, or about 3 mm.

The bracket sidewall 674 may be coupled to the second base sidewall 614b through a spot weld 680 of the first spot weld set 680a. The bracket sidewall 674 may have a bracket thickness Tl such that the spot weld 680 may fully extend through the bracket sidewall 674 and only partially into the second base sidewall 614b. In this manner, the spot weld 680 may not interact with the electrolyte positioned in the base 610. For example, the bracket thickness T1 may be between about 20 μm and 100 μm, such as between about 30 μm and 90 μm, such as between about 40 μm and 80 μm, such as between about 50 μm and 70 μm, or about 60 μm. However, in other embodiments, the spot weld may extend fully through both the bracket sidewall and the base sidewall.

The spot weld 680 may be distanced from a second bracket end 671, however, in other embodiments, the spot weld may be positioned along any other portion of the first bracket, including adjacent the second bracket end. Although only one spot weld 680 is depicted along the bracket sidewall 674 along the cross-sectional view of the bracket 670a in the X-Z plane, in other embodiments, there may be additional spot welds along other portions of the first bracket. In one example, the first bracket may include a spot weld coupling the bracket corner to the base corner in addition or in alternative to the spot weld coupling the bracket sidewall to the second base sidewall. The position of the spot weld 680 along the first bracket 670a and the dimensions of the spot weld 680 may be similar to the other spot welds of the first spot weld set 680a shown in FIG. 6A, however, in other embodiments, one or more of the position and/or the dimensions of the spot welds in the first spot weld set may be different from each other.

With reference to FIG. 6A, to form the battery 600, the bracket sheets that will later be cut to form the brackets 670a, 670b (e.g., similar to the brackets 670a, 670b but with a longer bracket flange 676 along the X-axis) may be coupled to the base sheet (e.g., the base sheet 952, as shown in FIGS. 9A and 9B) that will be cut to form the base 610 and to the cover sheet (e.g., the cover sheet 954, as shown in FIGS. 9A and 9B) that will be cut to form the cover 630. Specifically, each of the bracket sheets may be coupled to the corresponding portions of the base sidewalls 614b, 614d by spot welding the bracket sidewalls of the bracket sheets (e.g., the bracket sidewall 674, as shown in FIG. 6B) through spot weld sets 680a, 680b. Although not shown, the bracket flange of the bracket sheets may be coupled to the base flanges of the base sheet and the cover flange of the cover sheet through corresponding spot welds (not shown). The bracket sheets may be coupled to the base sheet after a battery cell stack is positioned in a base portion defined by the base sheet. However, in other embodiments, the brackets may be coupled to the before the battery cell stack is positioned in the base.

After the bracket sheets are coupled to the base sheet, the cover sheet may be coupled to the base sheet and the bracket sheets with the double weld 620, as noted above. The double weld 620 may weld over the spot welds coupling the bracket flange of the bracket sheets and the base flanges of the base sheet. After the base sheet, the cover sheet, and bracket sheets are coupled together with the double weld 620, the base sheet, the cover sheet, and the bracket flange may be laser cut to form the base 610, cover 630, and the brackets 670a, 670b as shown in FIG. 6A.

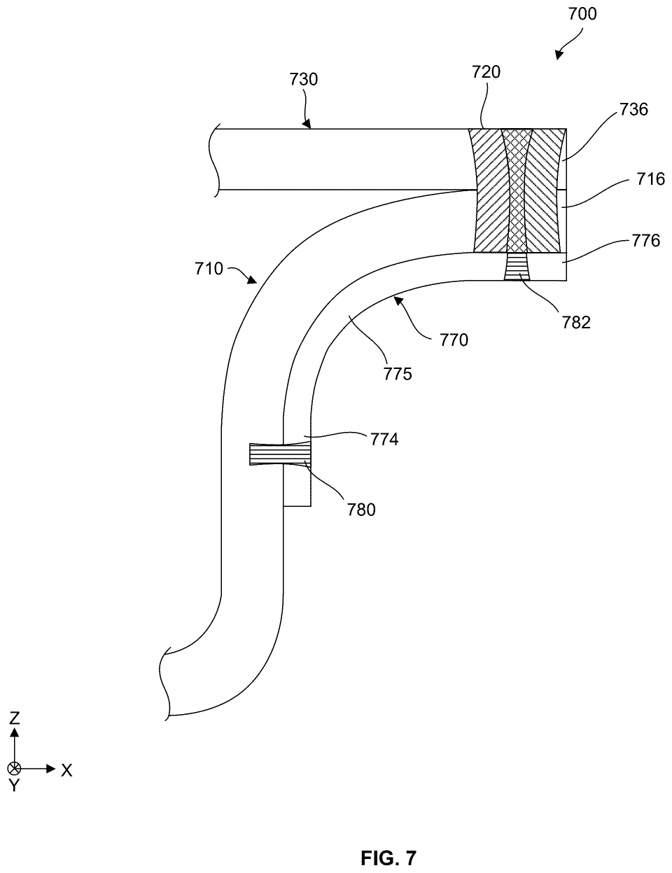

In other embodiments, the double or single weld of the battery may not extend to the bracket and, instead, the bracket may be coupled to the base through a separate weld. For example, FIG. 7 depicts an example battery 700 with a first weld 780 and a second spot weld 782. It is understood that features ending in like reference numerals as features discussed above are similar, except as noted below. The double weld 720 may extend through the cover extension portion 736 and the base flange 716. However, the double weld 720 may not extend though the bracket flange 776. Instead, the second spot weld 782 may couple the bracket 770 to the base 710. The second spot weld 782 may be similar to the first spot weld 780. However, in other embodiments, each of the spot welds may be different from each other, such as having different dimensions, shapes, or the like. The double weld 720 may extend partially over the second spot weld 782 (e.g., along an unshown portion of the second spot weld 782 that extends into the base 710)

The spot welds 780, 782 may be formed with a similar welding power and speed for each of the welds 780, 782. However, in other embodiments, each of the spot welds may be formed with a different welding power/speed. The bracket 770 may be coupled to the base 710 before or after the base 710 and cover 730 are coupled to each other. For example, the bracket 770 may be coupled to the base 710 with the spot welds 780, 782 before the base 710 and cover 730 are coupled to each other with the double weld 720. In this manner, the double weld 720 may be welded over the portion of the second spot weld 782 that extended into the base 710. However, in other embodiments, the first bracket may be coupled to the base with the second spot weld after the base and cover are welded together such that the second spot weld at least partially extends over the double weld in the base and/or cover. In other embodiments, the base and the cover may be coupled together through a single weld rather than a double weld.

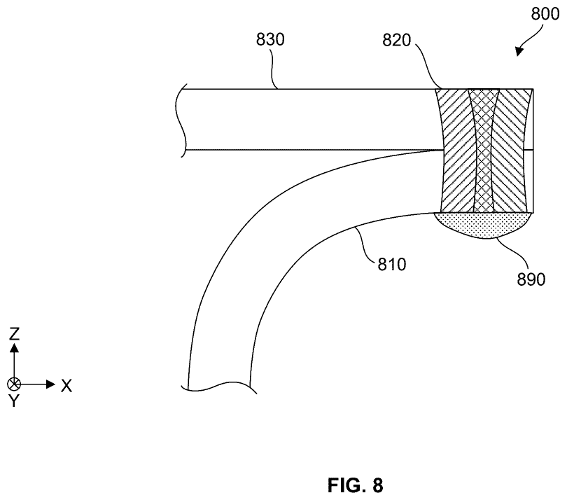

In some embodiments, the battery may include a covering material coupled over the weld to further increase the strength of the weld. For example, FIG. 8 depicts an example battery 800 with a covering material 890. It is understood that features ending in like reference numerals as features discussed above are similar, except as noted below. The covering material 890 may provide a sealing and/or adhesive quality between the double weld 820 and the base 810 to increase the coupling strength between the base 810 and the double weld 820. The covering material 890 may cover an entirety of the double weld 820 such that the covering material 890 forms a contiguous line over the double weld 820. In other embodiments, the covering material may be applied over the double weld in a pattern, such as a dotted pattern, a dashed pattern, or the like. In yet other embodiments, the covering material may be applied over the double weld along the cover to increase the coupling strength between the double weld and the cover. In a yet further embodiment, the covering material may be applied over the double weld along both the cover and base, and over the edges of the cover flange and base flange to increase the peel strength between all of the cover, base, and the double weld. In other embodiments, the covering material may be applied over a single weld rather than a double weld.

The covering material 890 may include a material that is capable of adhesive and/or sealing qualities. For example, the covering material 890 may include an adhesive, such as an epoxy adhesive, polyurethane adhesive, a polyimide adhesive, or the like. The adhesive may be a hot melt adhesive, reactive hot melt adhesive, pressure sensitive adhesive, contact adhesive, or the like. The covering material 890 may be a paste, liquid, film, solid, or the like. In one example, the covering material 890 may include an AB glue. In other embodiments, the covering material 890 may be a tape.

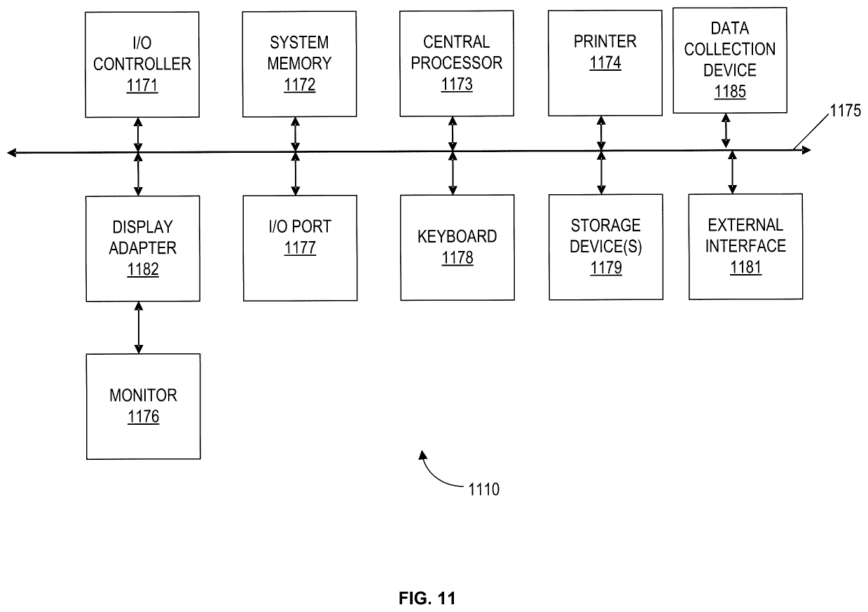

FIGS. 9A and 9B depicts a base sheet 952 and a cover sheet 954 for use in forming a battery. FIG. 10 depicts an example flowchart showing a process 1000 for forming the battery 900. It is understood that features ending in like reference numerals as features discussed above are similar, except as noted below. Unless step specified otherwise, the flowchart in FIG. 10 will be described with reference to the battery shown in FIGS. 9A and 9B. The below process can be performed by a computer system, such as the computer system 1110 depicted in FIG. 11.

Block 1010 may include inserting a battery cell stack in an interior volume defined by a base portion of a base sheet. For example, a battery cell stack (e.g., the battery cell stack 101, as shown in FIG. 1) may be inserted into the interior volume 950 at least partially defined by a base portion of a base sheet 952. The base portion of the base sheet 952 may be defined after a stamping process has formed a base sidewall and a base main wall (e.g., base sidewalls 614a, 614b, 614c, 614d and the base main wall 617, as shown in FIG. 6A). The interior volume 950 may be defined between the base portion and a cover sheet 954. In some embodiments, prior to, or after, the battery cell stack is inserted in the interior volume 950, a 3D scanner may be used to generate a geometric profile of the base sheet 952 and the cover sheet 954. A computer system may determine welding locations for welds based on this geometric profile. In some embodiments, bracket sheets may be coupled to one or more corners of the base sheet through spot welding sets to the base sheet.

Block 1020 may include welding a cover sheet to a flange of the base sheet with a first weld, wherein the flange extends from the base portion. For example, with reference to FIG. 9A, the cover extension portion 958 of the cover sheet 954 may be welded to the base sheet flange 956 extending from the base portion of the base sheet 952 with the first weld 922. Specifically, the first weld 922 may extend through the cover extension portion 958 from the cover sheet 954 through the base sheet 952. In some embodiments, the first weld may extend only partially through the base cover sheet (e.g., the first weld 522, as shown in FIG. 5). In other embodiments, the first weld may extend from the base partially or entirely through the cover. Where bracket sheets are coupled to the cover sheet and base sheet, the first weld may at least partially weld over the spot welds coupling the bracket sheet flanges to the base sheet flanges.

Block 1030 may include welding the cover sheet to the flange with a second weld at least partially overlapping the first weld. For example, with reference to FIG. 9B, the cover sheet extension portion 958 of the cover sheet 954 may be welded to the base sheet flange 956 of the base sheet 952 with the second weld 924 at least partially overlapping the first weld 922. This partial overlap may form a double weld 920 having an overlapping weld 926. As noted above, the power and speed of the welds 922, 924 may be substantially similar, however, in other embodiments, the power and speed of the welds may be different. Where bracket sheets are coupled to the cover sheet and base sheet, the second weld may at least partially weld over the spot welds coupling the bracket sheets to the cover sheet such that the double weld may completely weld over the spot welds coupling the bracket sheet flanges to the base sheet flanges (e.g., the double weld 620 extending through the cover extension portion 636, the second base flange 616b, and the bracket flange 676, as shown in FIG. 6B) or may partially overlap the spot weld coupling the bracket sheet flange to the base sheet flange (e.g., the double weld 720 extending through the cover extension portion 736 and the base flange 716, but only partially over the second spot weld 782, as shown in FIG. 7).

Block 1040 cutting the cover sheet and the base sheet to form the battery. For example, the cover sheet 954 and the base sheet 956 may be cut with a laser cutting process to form a battery. With reference to FIG. 2, the sheets may be cut such that flange ends 219, 239 of the base 210 and the cover 230 are aligned with the first weld end 223 of the double weld 220. With reference to FIG. 3, the sheets may be cut such that flange ends 319, 339 of the base 310 and the cover 330 includes a buffer having a buffer width W4 from the first weld end 323. With reference to FIG. 4, the sheets may cut through a portion of the double weld 420 in forming the flange ends 419, 439. With reference to FIGS. 6A, 6B, and 7 where bracket sheets are coupled to the cover sheet and base sheet, the base sheet, cover sheet, and bracket sheets may be cut to form the base 610, 710, cover 630, 730, and the brackets 670a, 670b, 770.

Any of the computer systems mentioned herein may utilize any suitable number of subsystems. Examples of such subsystems are shown in FIG. 11 in computer system 1110. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 11 are interconnected via a system bus 1175. Additional subsystems such as a printer 1174, keyboard 1178, storage device(s) 1179, monitor 1176 (e.g., a display screen, such as an LED), which is coupled to display adapter 1182, and others are shown. Peripherals and input/output (I/O) devices, which couple to I/O controller 1171, can be connected to the computer system by any number of means known in the art such as input/output (I/O) port 1177 (e.g., USB, Fire Wire®). For example, I/O port 1177 or external interface 1181 (e.g., Ethernet, Wi-Fi, etc.) can be used to connect computer system 1110 to a wide area network such as the Internet, a mouse input device, or a scanner. The interconnection via system bus 1175 allows the central processor 1173 to communicate with each subsystem and to control the execution of a plurality of instructions from system memory 1172 or the storage device(s) 1179 (e.g., a fixed disk, such as a hard drive, or optical disk), as well as the exchange of information between subsystems. The system memory 1172 and/or the storage device(s) 1179 may embody a computer readable medium. Another subsystem is a data collection device 1185, such as a camera, microphone, accelerometer, and the like. Any of the data mentioned herein can be output from one component to another component and can be output to the user.

A computer system can include a plurality of the same components or subsystems, e.g., connected together by external interface 1181, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor (e.g., aligning, determining, comparing, computing, calculating) may be performed in real-time. The term “real-time” may refer to computing operations or processes that are completed within a certain time constraint. The time constraint may be 1 minute, 1 hour, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom” or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A battery comprising:
a base including a base portion defining an interior volume and a base flange extending from the base portion;
a battery cell stack positioned in the interior volume; and
a cover welded to the base flange with a plurality of welds that at least partially overlap.

2. The battery of claim 1, wherein the plurality of welds overlap to define an overlapping weld having an overlap volume percentage of between 30% and 50% of a total volume of the plurality of overlapping welds.

3. The battery of claim 1, wherein the plurality of overlapping welds includes a first portion having a first width and a second portion having a second width that is less than the first width.

4. The battery of claim 3, wherein:
the base flange extends from the base portion to a base flange end; and
the first portion includes a first weld end terminally aligned with the base flange end.

5. The battery of claim 3, wherein:
the base flange extends from the base portion to a base flange end; and
the second portion includes a second weld end terminally aligned with the base flange end.

6. The battery of claim 3, wherein:
the base flange extends from the base portion to a base flange end;
the plurality of overlapping welds includes a third portion positioned between the first portion and the second portion;
the third portion includes a third width less than the first width and the second; and
the third portion includes a third weld end terminally aligned with the base flange end.

7. The battery of claim 1, wherein a first weld of the plurality of welds extends through the base and cover a first distance, and a second weld of the plurality of welds extends through the base and cover a second distance greater than the first distance.

8. The battery of claim 7, wherein the first weld extends through the base a distance less than a thickness of the base flange and the second weld fully extends through the thickness of the base.

9. The battery of claim 1, wherein the base flange and the base portion define a base corner therebetween, and the battery further comprises a bracket positioned on the base corner.

10. The battery of claim 1, further comprising a covering material positioned over the plurality of overlapping welds.

11. A battery comprising:
a base including a base portion defining an interior volume and a base flange extending from the base portion;
a battery cell stack positioned in the interior volume; and
a cover welded to the base flange with a first weld and a second weld at least partially overlapping with the first weld.

12. The battery of claim 11, wherein the first weld and second weld overlap to define an overlapping weld having an overlap volume percentage of between 30% and 50% of a total combined volume of the first and second welds.

13. The battery of claim 11, wherein the first and second welds define a first portion having a first width and a second portion having a second width that is less than the first width.

14. The battery of claim 13, wherein:
the base flange extends from the base portion to a base flange end; and
the first portion includes a first weld end terminally aligned with the base flange end.

15. The battery of claim 13, wherein:
the base flange extends from the base portion to a base flange end; and
the second portion includes a second weld end terminally aligned with the base flange end.

16. The battery of claim 13, wherein:
the base flange extends from the base portion to a base flange end;
the first and second welds define a third portion positioned between the first portion and the second portion;
the third portion includes a third width less than the first width and the second; and
the third portion includes a third weld end terminally aligned with the base flange end.

17. The battery of claim 11, wherein the base flange and the base portion define a base corner therebetween, and the battery further comprises a bracket positioned on the base corner.

18. The battery of claim 11, further comprising a covering material positioned over the first and second welds.

19. A method of forming a battery comprising:
inserting a battery cell stack in an interior volume defined by a base portion of a base sheet;
welding a cover sheet to a base flange of the base sheet with a first weld, wherein the base flange extends from the base portion;
welding the cover sheet to the base flange with a second weld at least partially overlapping the first weld; and
cutting the cover sheet and the base sheet to form the battery.

20. The method of claim 19, further comprising:
determining, with a scanner, a geometric profile of the base sheet and the cover sheet;
determining weld locations based on the geometric profile; and
welding the first weld and second weld based on the weld locations.
